(19) United States
(12) Patent Application Publication
(10) Pub. No.: US 2025/0220295 A1
(43) Pub. Date: Jul. 3, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Erina GOMI, Kanagawa (JP); Yosuke KIYAMA, Kanagawa (JP); Tsutomu HAMAGUCHI, Tokyo (JP); Tetsuji ISHIHARA, Tokyo (JP); Shota KAWARAZAKI, Tokyo (JP); Jiro KAWANO, Tokyo (JP); Ryosuke TAKEUCHI, Saitama (JP); Ryo MITSUMORI, Kanagawa (JP)

(73) Assignee: Sony Group Corporation, Tokyo (JP)

(21) Appl. No.: 18/849,541

(22) PCT Filed: Feb. 28, 2023
(86) PCT No.: PCT/JP2023/007238

§ 371 Date: Sep. 23, 2024

(30) Foreign Application Priority Data
Mar. 31, 2022 (JP) 2022-059428

(51) Int. Cl. H04N 23/62; G06F 3/04847; H04N 23/66; H04N 23/69

(52) U.S. Cl. CPC H04N 23/62; G06F 3/04847; H04N 23/66; H04N 23/69; G06F 2203/04806

(57) ABSTRACT

A smartphone (10) corresponding to an example of an information processing apparatus includes: an app execution unit (108a) that can execute a camera app of a camera (101) including a plurality of camera lenses (17) of different focal lengths including a zoom lens; and a display control unit (108b) that causes a display unit (106) to display a first user interface that clearly indicates a section of optical zoom of the zoom lens for a zoom function of the camera lens (17) included in the camera app.

### FIELD

The present disclosure relates to an information processing apparatus, an information processing method, and a program.

### BACKGROUND

In recent years, portable information processing apparatuses such as smartphones and tablet terminals are remarkably spreading. Furthermore, higher performance of the camera function in these portable information processing apparatuses is also rapidly advancing, and, for example, models including not only an out-camera and an in-camera, but also models including only an out-camera including a plurality of lenses of different focal lengths is spreading.

Furthermore, to enable a beginner to a professional to sufficiently utilize the camera function of such a high-performance camera according to each skill, various functions of photographing application software (app) that operates in the information processing apparatus are constantly expanded (see, for example, Patent Literature 1).

### CITATION LIST

### Patent Literature

Patent Literature 1: WO 2021/166264 A

### SUMMARY

### Technical Problem

However, the above-described conventional technique has still room for further improvement in improvement of convenience at a time of use of the photographing app.

Although, for example, the above-described conventional technique expands each function to widen a range in which a user can be involved in image quality, expansion of the function at a time of use of a zoom function in a case where a plurality of lenses of different focal lengths are provided is not sufficient.

Note that such a problem is not limited to a case where the photographing app is used, and is a problem common to operation apps for optical system devices in general that need to operate focal lengths.

Therefore, the present disclosure proposes an information processing apparatus, an information processing method, and a program that can further improve convenience at a time of use of an operation app for an optical system device.

### Solution to Problem

In order to solve the above problems, one aspect of an information processing apparatus according to the present disclosure includes: an app execution unit that can execute an operation app of an optical system device including a plurality of lenses of different focal lengths including a zoom lens; and a display control unit that causes a display unit to display a first user interface that clearly indicates a section of optical zoom of the zoom lens for a zoom function of the lens included in the operation app.

### BRIEF DESCRIPTION OF DRAWINGS

FIG. 1 is a schematic diagram (part 1) of a smartphone according to an embodiment of the present disclosure.

FIG. 2 is a schematic diagram (part 2) of the smartphone according to the embodiment of the present disclosure.

FIG. 3 is an explanatory view of a first lens, a second lens, and a third lens.

FIG. 4 is a block diagram illustrating a configuration example of the smartphone according to the embodiment of the present disclosure.

FIG. 5 is a diagram (part 1) illustrating a first display example of a UI related to a zoom function.

FIG. 6 is a diagram (part 2) illustrating the first display example of the UI related to the zoom function.

FIG. 7 is a diagram (part 3) illustrating the first display example of the UI related to the zoom function.

FIG. 8 is a diagram (part 4) illustrating the first display example of the UI related to the zoom function.

FIG. 9 is a diagram (part 1) illustrating a second display example of the UI related to the zoom function.

FIG. 10 is a diagram (part 2) illustrating the second display example of the UI related to the zoom function.

FIG. 11 is a diagram (part 3) illustrating the second display example of the UI related to the zoom function.

FIG. 12 is a diagram (part 4) illustrating the second display example of the UI related to the zoom function.

FIG. 13 is a diagram (part 1) illustrating a third display example of the UI related to the zoom function.

FIG. 14 is a diagram (part 2) illustrating the third display example of the UI related to the zoom function.

FIG. 15 is a diagram (part 3) illustrating the third display example of the UI related to the zoom function.

FIG. 16 is a flowchart illustrating a processing procedure executed by the smartphone.

FIG. 17 is a hardware configuration diagram illustrating an example of a computer that implements functions of the smartphone.

### DESCRIPTION OF EMBODIMENTS

Hereinafter, an embodiment of the present disclosure will be described in detail with reference to the drawings. Note that, in the following embodiment, the same components will be assigned the same reference numerals, and redundant description will be omitted.

Furthermore, a case where an information processing apparatus used by a user is a smartphone 10 will be described below citing an example. Furthermore, a photographing app that operates on the smartphone 10 may be referred to as a “camera app” below.

Furthermore, the present disclosure will be described in order of items described below.
1. Configuration of Smartphone
1-1. Schematic Configuration of Smartphone
1-2. Functional Configuration of Smartphone
2. Display Example of UI Related to Zoom Function
2-1. First Display Example
2-2. Second Display Example
2-3. Third Display Example
3. Processing Procedure
4. Modified Example
5. Hardware Configuration
6. Conclusion

### 1. CONFIGURATION OF SMARTPHONE

### 1-1. Schematic Configuration of Smartphone

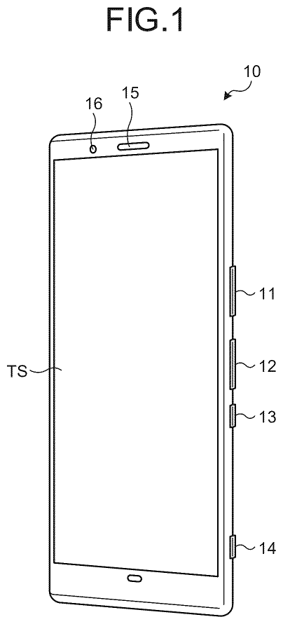

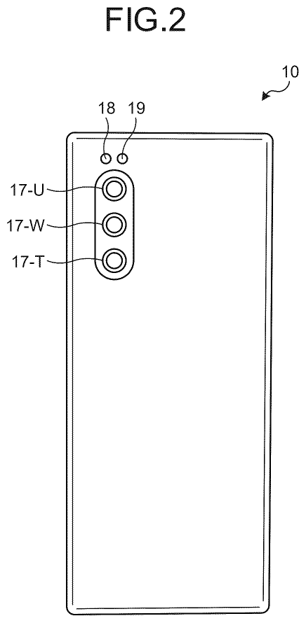

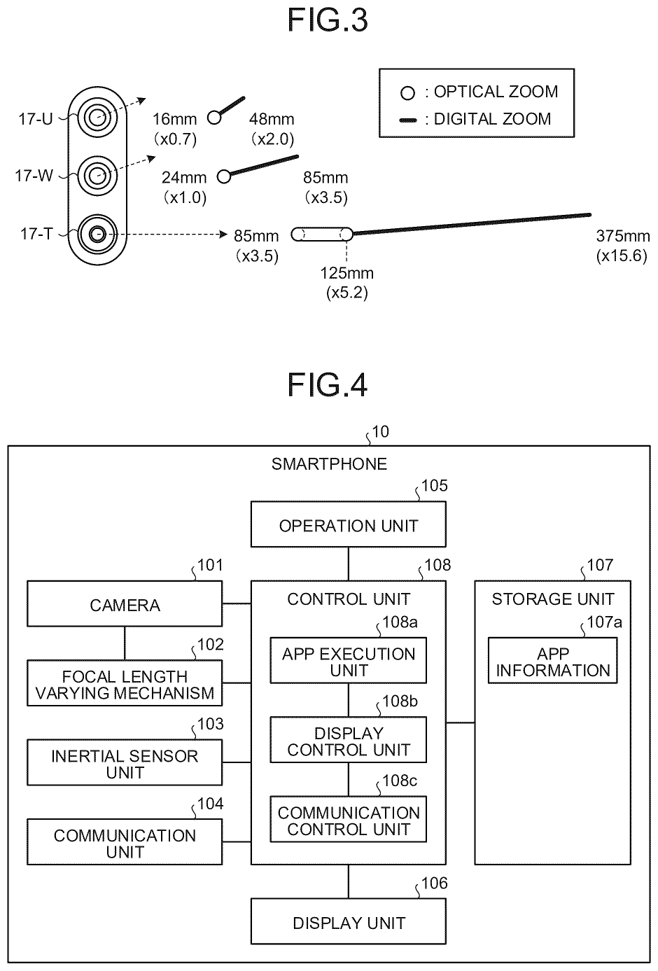

FIG. 1 is a schematic diagram (part 1) of the smartphone 10 according to the embodiment of the present disclosure. Furthermore, FIG. 2 is a schematic diagram (part 2) of the smartphone 10 according to the embodiment of the present disclosure. Note that FIG. 1 illustrates a configuration of the front surface side of the smartphone 10. Furthermore, FIG. 2 illustrates a configuration on the back surface side of the smartphone 10. Furthermore, FIG. 3 is an explanatory view of a first lens 17-U, a second lens 17-W, and a third lens 17-T.

The smartphone 10 is a portable information processing apparatus that has a camera function. As illustrated in FIG. 1, a touch screen TS is provided on the front surface of the smartphone 10. The touch screen TS is a device formed by integrating a touch panel and a display. The touch screen TS detects a touch operation of the user. As a detection method of the touch screen TS, known methods such as a capacitance method, a resistive film method, a surface acoustic wave method (or an ultrasonic method), an infrared method, an electromagnetic induction method, and a load detection method are used.

The touch screen TS has a rectangular shape. At one end part in a longitudinal direction of the smartphone 10, for example, a camera lens 16 for an in-camera and an earpiece 15 are provided. A speaker is provided to the earpiece 15. Although not illustrated, at the other end part of the smartphone 10, for example, a mouthpiece including a microphone is provided.

On the side surface of the smartphone 10 along the long side of the touch screen TS, for example, a volume key 11, a fingerprint sensor 12, a power key 13, and a camera key 14 are provided. The volume key 11 is a hardware key that adjusts the volume. The fingerprint sensor 12 is a device that reads a fingerprint. The power key 13 is a hardware key that turns on/off a power supply. The camera key 14 is a hardware key that activates a camera app. The camera key 14 is used as a shutter at a time of photographing. The camera key 14 is provided at, for example, a position closer to the mouthpiece (on an opposite side to the earpiece 15 side) than the center part of the side surface of the smartphone 10.

Furthermore, as illustrated in FIG. 2, a plurality of camera lenses 17 of different focal lengths are provided on the back surface of the smartphone 10. The camera lenses 17 are camera lenses for out-cameras. In the example in FIG. 2, the camera lenses 17 are provided as, for example, the first lens 17-U, the second lens 17-W, and the third lens 17-T as the plurality of camera lenses 17.

Here, as illustrated in FIG. 3, the first lens 17-U is, for example, an ultra wide angle lens whose focal length is 16 mm. Furthermore, the second lens 17-W is, for example, a standard wide angle lens whose focal length is 24 mm. Furthermore, the third lens 17-T is, for example, a telephoto lens whose focal length is 85 mm to 125 mm. That is, the third lens 17-T is an optical zoom lens that can vary the focal length within the range of 85 mm to 125 mm. The smartphone 10 switches optical zoom of the camera function by selecting these first lens 17-U, second lens 17-W, and third lens 17-T via the camera app. When the first lens 17-U is selected, the smartphone 10 switches optical zoom to 16 mm. Furthermore, when the second lens 17-W is selected, the smartphone 10 switches optical zoom to 24 mm. Furthermore, when the third lens 17-T is selected, the smartphone 10 can change the magnification within the range of 85 mm to 125 mm by optical zoom. “85 mm to 125 mm” in such a case corresponds to an “optical zoom section” described later.

Furthermore, when the first lens 17-U is selected, the smartphone 10 can change the magnification within the range of 16 mm to 48 mm by digital zoom. Furthermore, when the second lens 17-W is selected, the smartphone 10 can change the magnification within the range of 24 mm to 85 mm by digital zoom. Furthermore, when the third lens 17-T is selected, the smartphone 10 can change the magnification within the range of 125 mm to 375 mm by digital zoom.

Note that, for example, “×0.7” illustrated in FIG. 3 is a magnification conversion value at each distance when the focal length of 24 mm is 1.0 time. In the following description, a setting value of the zoom function on a User Interface (UI) of the camera app may be indicated by this magnification conversion value.

By the way, according to a zoom function of a conventional camera app, when a user wants to change the magnification, the user needs to select the camera lens 17 according to a desired magnification every time. Furthermore, when the user wants to change the magnification beyond a settable range of the selected camera lens 17, the user needs to select the camera lens 17 having the second largest or smallest focal length after the currently set camera lens 17.

This operation is similar to a general digital camera. Hence, such an operation has an advantage that the user can perform the zoom operation with the same sense as that for the digital camera. However, according to such an operation, the user needs to select the camera lens 17 matching the desired magnification every time as described above.

Furthermore, the UI of the zoom function of the conventional camera app also has a problem that it is difficult for the user to grasp a range that can be set by optical zoom in a case where the camera lens 17 includes a zoom lens like the third lens 17-T.

Hence, according to the information processing method according to the embodiment of the present disclosure, in a case where the plurality of camera lenses 17 of the different focal lengths including the zoom lens are provided, a UI (corresponding to an example of a “first user interface”) that clearly indicates an optical zoom section (85 mm to 125 mm) is presented to the user. Furthermore, according to the information processing method according to the embodiment of the present disclosure, a UI (corresponding to an example of a “second user interface”) that continuously indicates a range from a minimum magnification to a maximum magnification that can be set to all of the plurality of camera lenses 17 is presented to the user. A specific example thereof will be described later with reference to FIG. 3 and subsequent drawings.

The description returns to explanation of FIG. 2. A flash light 18 and a Red Green Blue Clear-Infrared (RGBC-IR) sensor 19 are provided near the camera lens 17. The flash light 18 is a device that is turned on at the time of photographing to brightly illuminate a photographing target. The RGBC-IR sensor 19 is a device that detects a component of a light source in a photographing environment at the time of photographing. The RGBC-IR sensor 19 acquires, for example, infrared information on surroundings of the smartphone 10, and specifies a light source environment such as an outdoor environment, an incandescent lamp, or a fluorescent lamp.

### 1-2. Functional Configuration of Smartphone

Next, the functional configuration of the smartphone 10 will be described. FIG. 4 is a block diagram illustrating a configuration example of the smartphone 10 according to the embodiment of the present disclosure. Note that FIG. 4 illustrates only components necessary for describing features of the embodiment of the present disclosure, and omits description of general components.

In other words, each component illustrated in FIG. 4 is functionally conceptual, and does not necessarily need to be physically configured as illustrated. For example, the specific modes of distribution and integration of each block are not limited to the illustrated modes, and all or part thereof can be functionally or physically distributed and integrated in an arbitrary unit according to various loads, usage conditions, and the like.

Furthermore, the description to be made with reference to FIG. 4 may simplify or omit description of the already described components.

As illustrated in FIG. 4, the smartphone 10 includes a camera 101, a focal length varying mechanism 102, an inertial sensor unit 103, a communication unit 104, an operation unit 105, a display unit 106, a storage unit 107, and a control unit 108.

The camera 101 is a camera mounted on the smartphone 10, and includes the above-described camera lenses 16 and 17. The focal length varying mechanism 102 is a mechanism that varies the focal length of the above-described third lens 17-T that is the zoom lens within the range of 85 mm to 125 mm.

The inertial sensor unit 103 includes a G sensor and a gyro sensor. The inertial sensor unit 103 measures an angular velocity and an acceleration of the smartphone 10. The control unit 108 to be described later calculates the posture/direction, the speed, the position, and the like of the smartphone 10 in real time using this measurement data.

The communication unit 104 is implemented as a communication module or the like. The communication unit 104 implements communication between the smartphone 10 and an external apparatus other than the smartphone 10.

The operation unit 105 is an operation component mounted on the smartphone 10. The display unit 106 is a display component mounted on the smartphone 10.

Note that the operation unit 105 and the display unit 106 may be integrated as the touch screen TS. Hence, the operation unit 105 may be a software component, and, in the embodiment of the present disclosure, the operation unit 105 may be, for example, a Graphical User Interface (GUI) that the camera app operably displays on the display unit 106.

The storage unit 107 is implemented by, for example, a semiconductor memory element such as a Random Access Memory (RAM), a Read Only Memory (ROM), or a flash memory. In the example illustrated in FIG. 4, the storage unit 107 stores app information 107a. The app information 107a is information that includes a program of the camera app, various parameters used during an operation of the camera app, and the like.

The control unit 108 is a controller, and is implemented by, for example, a Central Processing Unit (CPU), a Micro Processing Unit (MPU), or the like by executing a program according to the embodiment of the present disclosure stored in the storage unit 107 using a RAM as a working area. Note that the control unit 108 may be implemented by an integrated circuit such as an Application Specific Integrated Circuit (ASIC) or a Field Programmable Gate Array (FPGA).

The control unit 108 includes an app execution unit 108a, a display control unit 108b, and a communication control unit 108c, and implements or executes a function and an action of information processing described below.

The app execution unit 108a reads the app information 107a stored in the storage unit 107 and executes the camera app. For example, the app execution unit 108a selects the camera lens 17 of the camera 101 according to operation contents of the operation input from the operation unit 105 and related to the zoom function.

Furthermore, the app execution unit 108a sets the zoom magnification of the camera lens 17 according to the operation contents of the operation related to the zoom function likewise. Furthermore, to set the zoom magnification, the app execution unit 108a controls the focal length varying mechanism 102 as necessary, and sets the focal length of the third lens 17-T within the range of 85 mm to 125 mm.

Furthermore, the app execution unit 108a causes the camera 101 to perform photographing at the set zoom magnification using the selected camera lens 17 according to a photographing operation input from the operation unit 105. Furthermore, when executing the camera app, the app execution unit 108a causes the display control unit 108b to perform display control of visual information including various UIs.

The display control unit 108b performs display control of the visual information on the display unit 106 at the time of execution of the camera app on the basis of a measurement result of the inertial sensor unit 103 and an instruction of the app execution unit 108a. The communication control unit 108c performs communication control on an external apparatus when executing the camera app.

### 2. DISPLAY EXAMPLE OF UI RELATED TO ZOOM FUNCTION

### 2-1. First Display Example

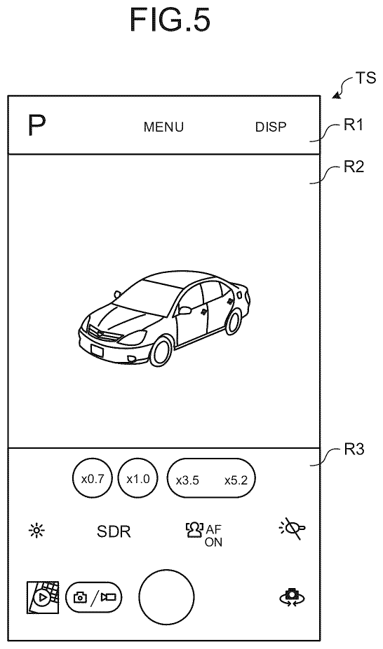

Next, the first display example of the UI related to the zoom function according to the embodiment of the present disclosure will be described with reference to FIGS. 5 to 8. FIGS. 5 to 8 are diagrams (part 1) to (part 4) illustrating the first display example of the UI related to the zoom function.

As illustrated in FIG. 5, the above-described display control unit 108b displays various visual information related to execution of the camera app on a first region R1, a second region R2, and a third region R3 of the touch screen TS.

In the first region R1, portal app information of the camera app such as a currently set photographing mode and menu is displayed. In the second region R2, the selected camera lens 17 and a monitor screen of a camera-through image obtained at the set zoom magnification are displayed.

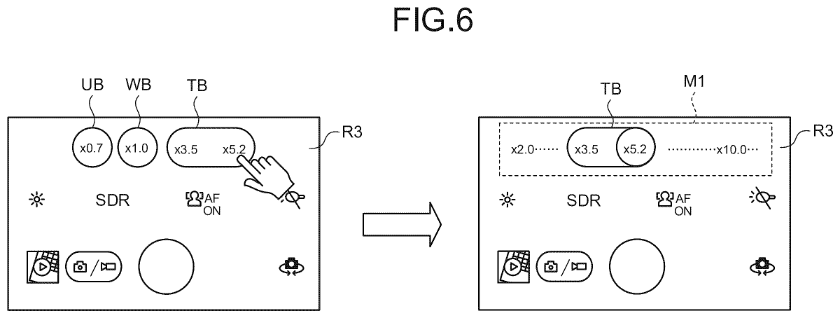

In the third region R3, a UI for various operations of the camera app is displayed. Here, as illustrated in FIG. 6, in the third region R3, a first magnification setting button UB, a second magnification setting button WB, and a third magnification setting button TB are displayed as UIs related to the zoom function.

The first magnification setting button UB corresponds to a selection button of the above-described first lens 17-U. The second magnification setting button WB corresponds to a selection button of the above-described second lens 17-W. The third magnification setting button TB corresponds to a selection button of the above-described third lens 17-T.

The first magnification setting button UB is a button having a perfect circular shape, and a magnification conversion value “×0.7” matching the focal length of the first lens 17-U is indicated. The second magnification setting button WB is a button having a perfect circular shape likewise, and a magnification conversion value “×1.0” matching the focal length of the second lens 17-W is indicated. The third magnification setting button TB is a button having an oval shape, and a section “×3.5 to ×5.2” (85 mm to 125 mm) of the magnification conversion value matching a variable focal length of the third lens 17-T, that is, the above-described optical zoom section is indicated.

That is, in a case where the smartphone 10 includes the plurality of camera lenses 17 of the different focal lengths, the display control unit 108b presents to the user a UI that clearly indicates the focal length matching each camera lens 17.

In particular, as indicated by the third magnification setting button TB, in a case where the smartphone 10 includes an optical zoom lens of a variable focal length, the display control unit 108b presents a UI that clearly indicates the optical zoom section (85 mm to 125 mm) that can be set by this zoom lens. Consequently, the user can easily grasp the matching focal length and settable optical zoom section for each of the plurality of camera lenses 17 included in smartphone 10.

Here, as illustrated in the left diagram of FIG. 6, it is assumed that, for example, the user performs a tap operation on the third magnification setting button TB. Then, as indicated at an M1 part in the right diagram of FIG. 6, the display control unit 108b presents to the user a UI that continuously indicates a range that includes the optical zoom section of the third lens 17-T and can be set to all of the plurality of camera lenses 17.

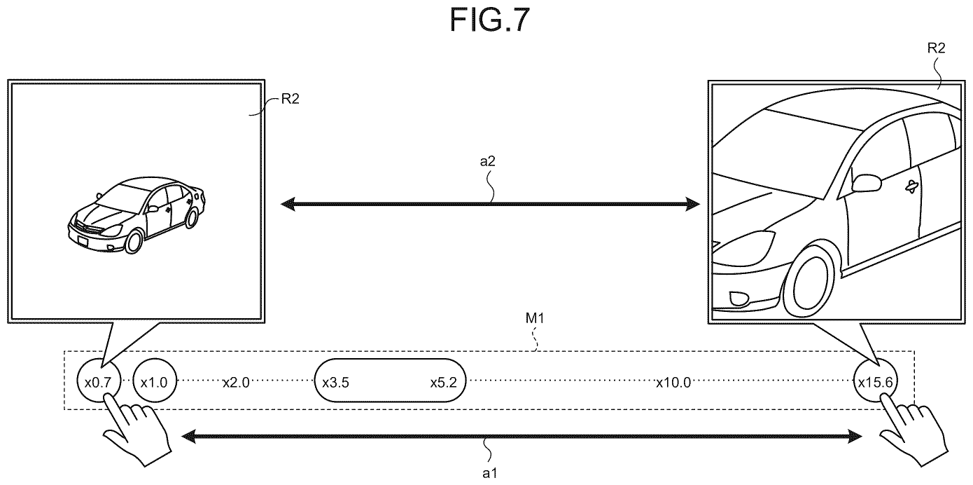

More specifically, as indicated at the M1 part in FIG. 7, the display control unit 108b presents to the user a UI that continuously indicates a range from the minimum magnification to the maximum magnification that can be set to all of the plurality of camera lenses 17. In the case of the embodiment of the present disclosure, as illustrated in FIG. 7, the minimum magnification is “×0.7” matching the focal length of the first lens 17-U, and the maximum magnification is “×15.6” matching the maximum value of digital zoom of the third lens 17-T. Hereinafter, the UI that continuously indicates the range from the minimum magnification to the maximum magnification that can be set to all of the plurality of these camera lenses 17 will be referred to as a “seamless zoom UI” as appropriate.

Furthermore, as illustrated in FIG. 7, when the user performs a swipe operation along this seamless zoom UI (see an arrow a1 in FIG. 7), the display control unit 108b performs display control to zoom in or zoom out the monitor screen in the second region R2 according to the swipe operation (see an arrow a2 in FIG. 7).

Furthermore, when the user releases the finger from the seamless zoom UI, the app execution unit 108a sets the zoom magnification of the camera 101 associated with the position on the seamless zoom UI from which the user has released the finger. Furthermore, as illustrated in FIG. 7, the optical zoom section “×3.5-×5.2” (85 mm to 125 mm) that can be set by the zoom lens is also grouped by one oval button and clearly indicated on the seamless zoom UI.

Note that, although FIGS. 6 and 7 illustrate the examples where the display control unit 108b displays the seamless zoom UI as the UI related to the zoom function, the seamless zoom UI may not be enabled according to a combination of the type and the set photographing mode of the camera app, on/off settings of the seamless zoom UI, or the like.

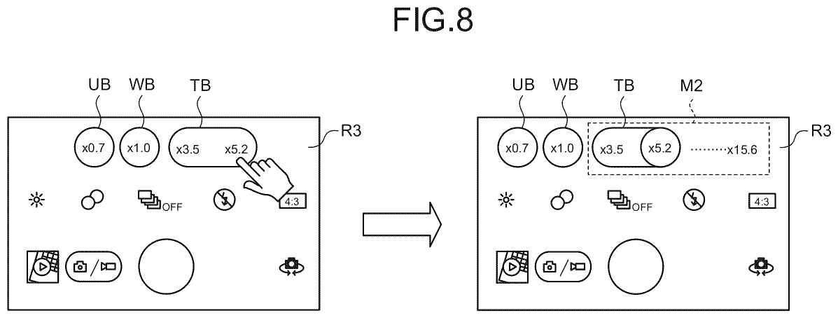

FIG. 8 illustrates an example of a case where the seamless zoom UI is not enabled in the first display example. As illustrated in the left diagram of FIG. 8, it is assumed that the user performs the tap operation on, for example, the third magnification setting button TB. Then, as indicated at an M2 part in the right diagram of FIG. 8, the display control unit 108b presents to the user a UI that continuously indicates only a range that includes the optical zoom section of the third lens 17-T and can be set in a case where the third lens 17-T is selected.

As described above, off settings of the seamless zoom UI that does not enable the seamless zoom UI can be performed from the on/off settings UI of the seamless zoom UI whose illustration is omitted. Furthermore, examples of the type of the above-described camera app include “photo pro”, “video pro”, and “cinema pro”. “Photo pro” is a photo shooting dedicated app that pursues full-fledged operability and functions of a digital camera. “Video pro” is a video shooting dedicated app. “Cinema pro” is a video shooting dedicated app that pursues providing an operational feeling and image creation of photographing with a professional cinema camera. Furthermore, the above-described photographing modes include a “Basic” mode that makes it possible to easily perform photographing, and various modes such as “Auto”, “P”, “S”, and “M” that are well known as photographing modes of the digital camera. The seamless zoom UI may be automatically enabled or disabled as appropriate according to a combination of these type and set photographing mode of the camera app.

### 2-2. Second Display Example

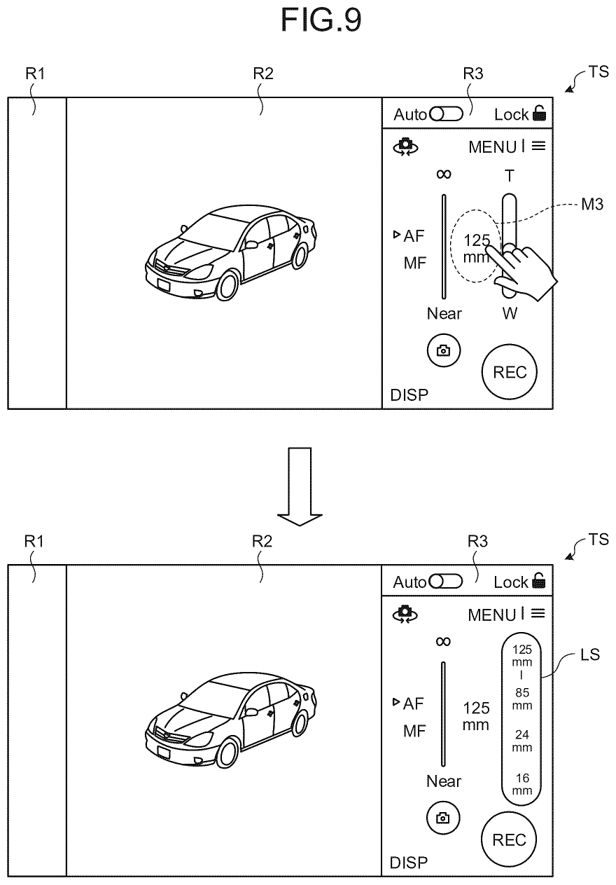

Next, the second display example related to the zoom function according to the embodiment of the present disclosure will be described with reference to FIGS. 9 to 12. FIGS. 9 to 12 are diagrams (part 1) to (part 4) illustrating the second display example of the UI related to the zoom function.

In the second display example, the touch screen TS is rotated by 90 degrees from the first display example. In such a case, as illustrated in FIG. 9, the display control unit 108b arranges the first region R1, the second region R2, and the third region R3 side by side in order from the left, for example.

Furthermore, the display control unit 108b displays the currently selected camera lens 17 in the third region R3 as indicated at an M3 part in FIG. 9. Here, as indicated at the M3 part, it is assumed that the third lens 17-T associated with “125 mm”, that is, this focal length is selected.

Furthermore, when the user performs the tap operation on this M3 part, the display control unit 108b superimposes and displays a lens selection screen LS on the third region R3 in response to this tap operation as illustrated in the lower diagram of FIG. 9.

As illustrated in FIG. 9, the lens selection screen LS is a screen on which focal lengths “16 mm”, “24 mm”, and “85 mm to 125 mm” associated with the selectable camera lenses 17 are indicated in an oval region in a selectable manner. For the third lens 17-T that is the zoom lens, the optical zoom section “85 mm to 125 mm” is clearly indicated. The lens selection screen LS is displayed when, for example, the above-described on/off settings of the seamless zoom UI are on.

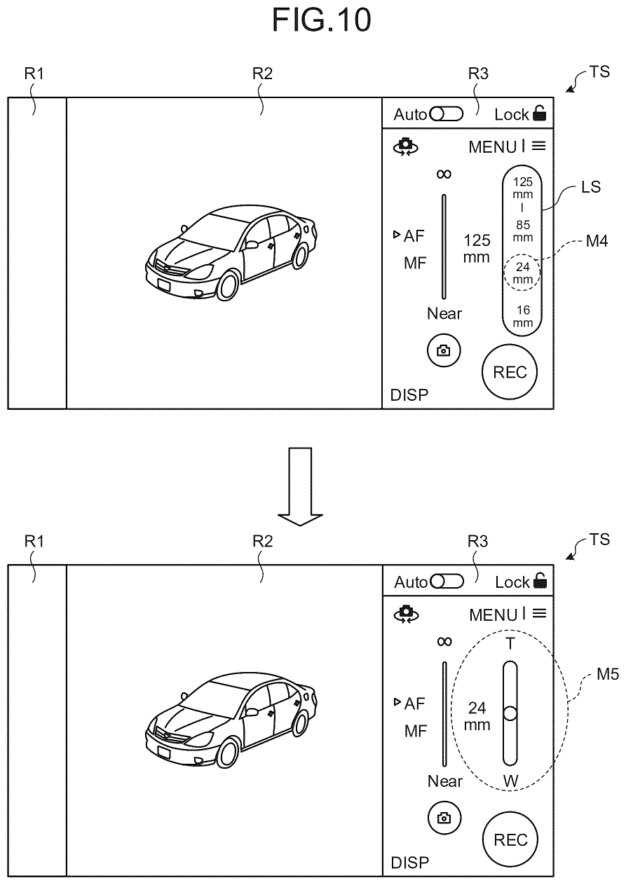

Furthermore, as indicated at an M4 part in FIG. 10, it is assumed that the user selects the second lens 17-W associated with “24 mm”, that is, this focal length on the lens selection screen LS. Furthermore, as illustrated in the lower diagram of FIG. 10, the lens selection screen LS is erased, and a slide bar corresponding to a zoom lever indicated by T (Telephoto) and W (Wide) of the digital camera appears from the lower side of the lens selection screen LS as indicated at an M5 part in the lower diagram of FIG. 10.

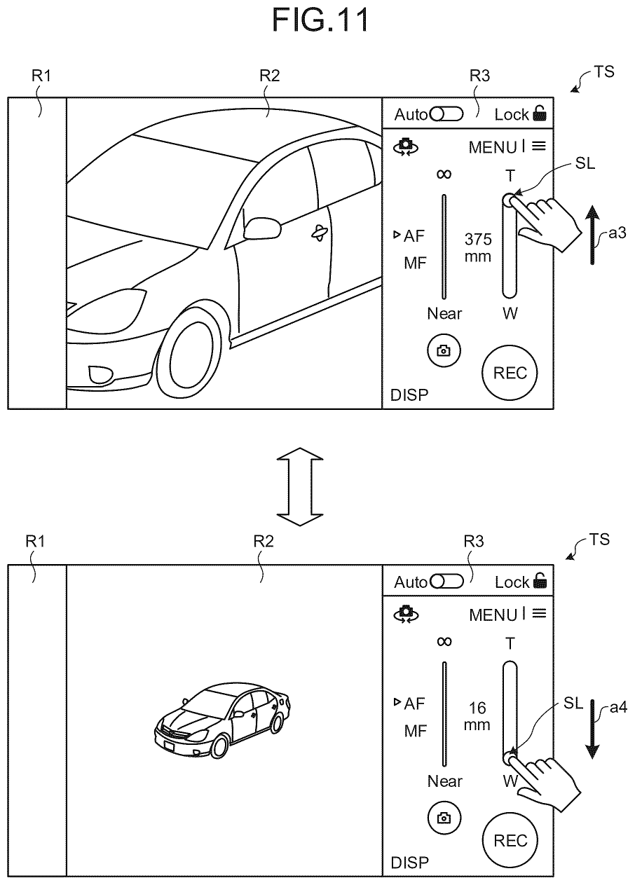

In the second display example, the slide bar of this M5 part functions to correspond to the above-described seamless zoom UI. More specifically, as illustrated in the upper diagram of FIG. 11, when the user moves a slider SL of this slide bar toward the “T” side beyond the center position of the bar (see an arrow a3 in the upper diagram), the display control unit 108b zooms in the monitor screen of the second region R2 according to the movement amount of the slider SL. Furthermore, the focal length at the above-described M3 part is displayed as the currently displayed zoom magnification, and changes to “375 mm” at maximum.

On the other hand, as illustrated in the lower diagram of FIG. 11, when the user moves the slider SL toward the “W” side beyond the center position of the bar (see an arrow a4 in the lower diagram), the display control unit 108b zooms out the monitor screen of the second region R2 according to the movement amount of the slider SL. Furthermore, the focal length at the above-described M3 part is displayed at the currently displayed zoom magnification, and changes to “16 mm” at minimum.

Furthermore, when the user releases the finger from the slider SL, the app execution unit 108a sets the zoom magnification of the camera 101 associated with the position of the slider SL from which the user has released the finger.

Note that, although the description has been made with reference to FIGS. 10 and 11 citing the example where the user selects “24 mm” on the lens selection screen LS as indicated at the M4 part in FIG. 10, the smartphone 10 operates as illustrated in FIG. 11 if the seamless zoom UI is enabled even in a case where “16 mm” or “85 mm to 125 mm” is selected.

Furthermore, similarly to the first display example, the display control unit 108b may not enable the seamless zoom UI in the second display example, either.

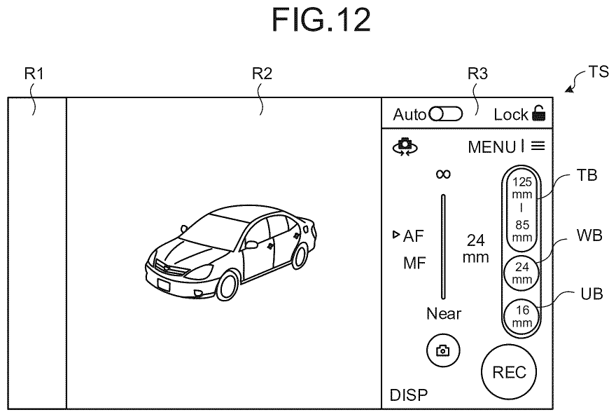

FIG. 12 illustrates an example in such a case. First, it is assumed that the user performs the tap operation on the M3 part illustrated in FIG. 9. Then, the display control unit 108b superimposes and displays the first magnification setting button UB, the second magnification setting button WB, and the third magnification setting button TB in the third region R3 in response to the tap operation as illustrated in FIG. 12.

The first magnification setting button UB, the second magnification setting button WB, and the third magnification setting button TB illustrated in FIG. 12 are indicated as focal lengths, and are similar to the first magnification setting button UB, the second magnification setting button WB, and the third magnification setting button TB illustrated in FIGS. 6 and 8. Furthermore, when the user performs the tap operation on any one of these buttons, each button is erased, and the slide bar indicated at the above-described M5 part appears from the lower side.

However, when the seamless zoom UI is not enabled, the slide bar of this M5 part does not function as the above-described seamless zoom UI. That is, when each camera lens 17 is selected, the slide bar of this M5 part functions as the UI that continuously indicates only a settable range including the range of the digital zoom of the selected camera lens 17. When, for example, the first magnification setting button UB is selected, the magnification can be set within the range of 16 mm to 48 mm using the slide bar indicated at the M5 part. Furthermore, when, for example, the second magnification setting button WB is selected, the magnification can be set within the range of 24 mm to 85 mm using the slide bar indicated at the M5 part. Furthermore, when, for example, the third magnification setting button TB is selected, the magnification can be set within the range of 85 mm to 375 mm using the slide bar indicated at the M5 part.

### 2-3. Third Display Example

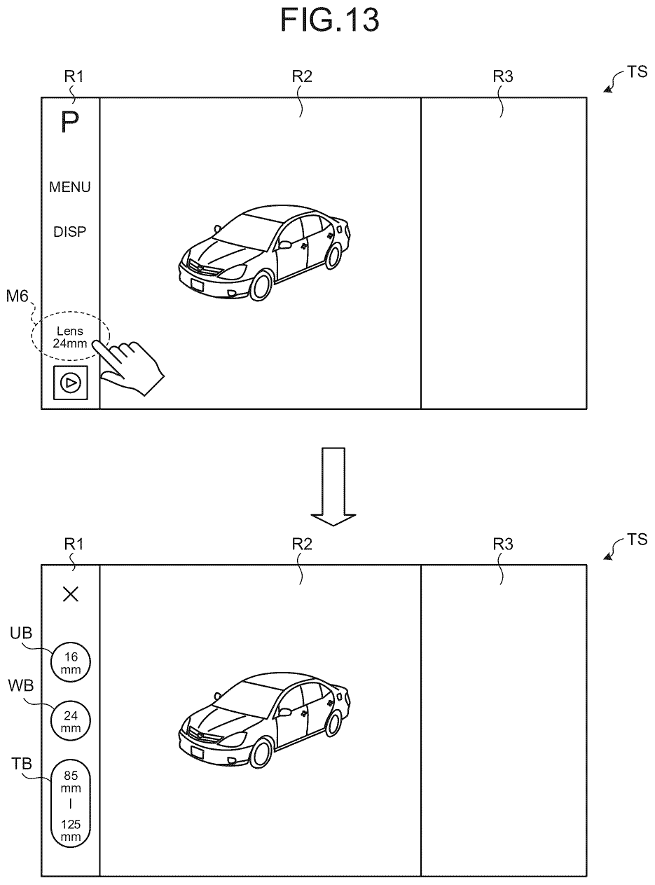

Next, the third display example related to the zoom function according to the embodiment of the present disclosure will be described with reference to FIGS. 13 to 15. FIGS. 13 to 15 are diagrams (part 1) to (part 3) illustrating the third display example of the UI related to the zoom function.

As illustrated in FIG. 13, the third display example assumes that the display control unit 108b arranges the first region R1, the second region R2, and the third region R3 side by side similar to the second display example.

Furthermore, the display control unit 108b displays the currently selected camera lens 17 in the first region R1 as indicated at an M6 part in FIG. 13. Here, as indicated at the M6 part, it is assumed that the second lens 17-W associated with “24 mm”, that is, this focal length is selected.

Furthermore, when the user performs the tap operation on this M6 part, the display control unit 108b displays the first magnification setting button UB, the second magnification setting button WB, and the third magnification setting button TB similar to those illustrated in FIG. 12 in the first region R1 in response to the tap operation as illustrated in the lower diagram of FIG. 13.

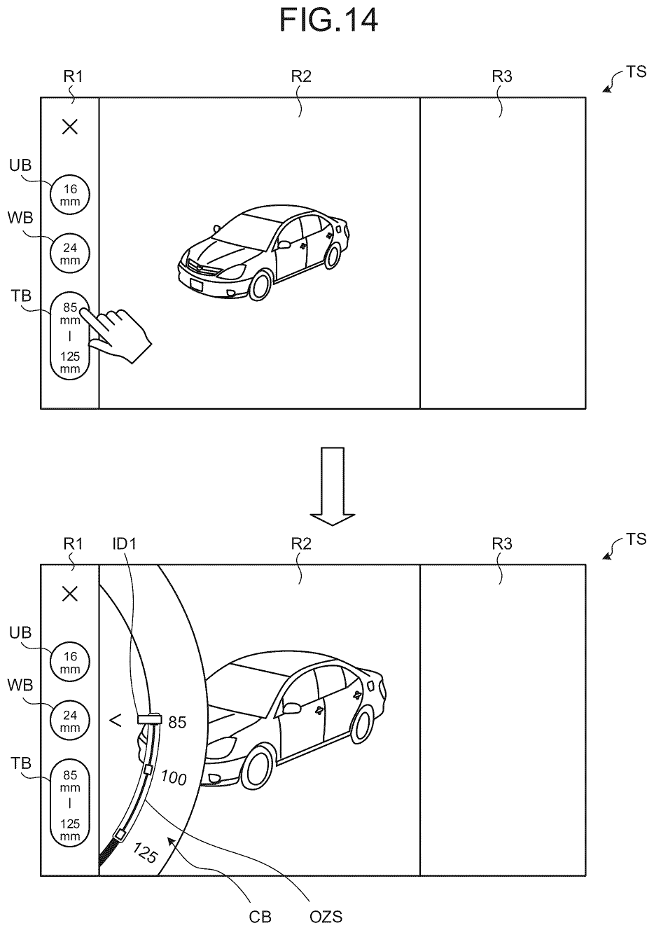

Furthermore, when, for example, the user performs a tap operation on the third magnification setting button TB as illustrated in the upper diagram of FIG. 14, the display control unit 108b superimposes and displays a magnification setting ring CB in the second region R2 as illustrated in the lower diagram of FIG. 14.

The magnification setting ring CB is an operation component on which scales that indicate focal lengths associated with magnifications of the optical zoom and the digital zoom are indicated on the outer circumference of an arc shape and that is provided rotatably around the center of the arc. On the magnification setting ring CB, an optical zoom section OZS (85 mm to 125 mm) is clearly indicated separately from a digital zoom section.

Consequently, the user can easily grasp the corresponding focal length and settable optical zoom section OZS (85 mm to 125 mm) for each of the plurality of camera lenses 17 (the third lens 17-T in the example in FIG. 14) included in the smartphone 10.

Furthermore, when the user rotates the magnification setting ring CB to adjust the scale of a desired focal length to an index ID1, the zoom magnification associated with the corresponding scale is set.

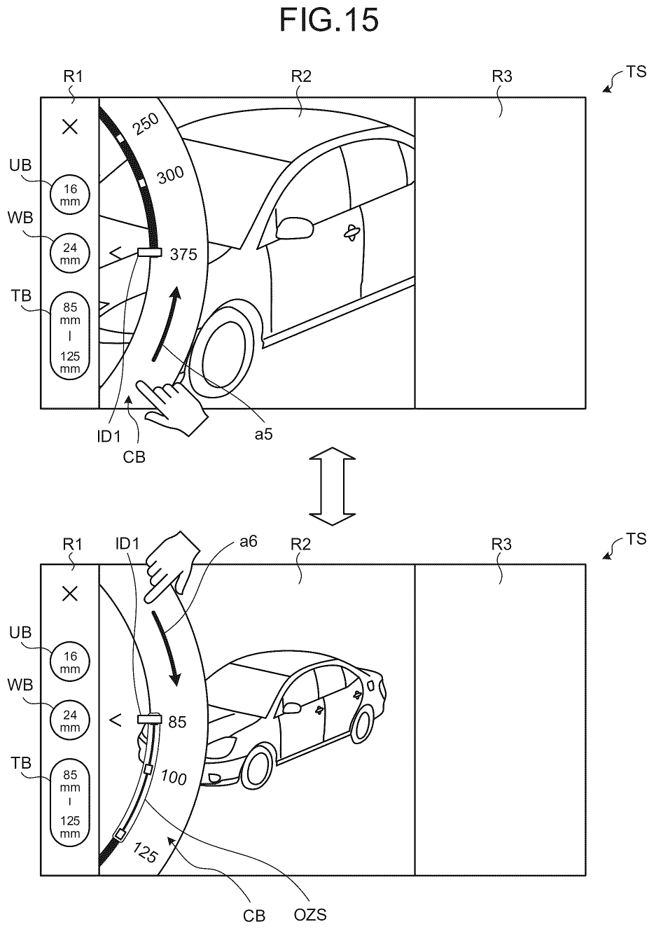

More specifically, as illustrated in the upper diagram of FIG. 15, when the user rotates the magnification setting ring CB counterclockwise by, for example, a drag operation (see an arrow a5 in the upper diagram), the display control unit 108b zooms in the monitor screen of the second region R2 according to the rotation amount of the magnification setting ring CB. Furthermore, the app execution unit 108a sets the zoom magnification associated with the focal length (here, “375” mm) of the scale that has been adjusted to the index ID1 by the user.

On the other hand, as illustrated in the lower diagram of FIG. 15, when the user rotates the magnification setting ring CB clockwise by the drag operation likewise (see an arrow a6 in the lower diagram), the display control unit 108b zooms out the monitor screen of the second region

R2 according to the rotation amount of the magnification setting ring CB. Furthermore, the app execution unit 108a sets the zoom magnification associated with the focal length (here, “85” mm) of the scale that has been adjusted to the index ID1 by the user.

Note that, although the magnification setting ring CB is rotated by the user's drag operation in the example in FIG. 15, the magnification setting ring CB may be rotated by a user's pinch-out/pinch-in operation on the touch screen TS. The pinch-out/pinch-in operation is a touch operation where the user widens or narrows an interval between two fingers while bringing the two fingers into contact with the touch screen TS.

In such a case, the app execution unit 108a detects a change amount of the interval between the two fingers as a pinch amount. Furthermore, the display control unit 108b rotates the magnification setting ring CB by a rotation amount matching the pinch amount detected by the app execution unit 108a. Furthermore, the display control unit 108b zooms out/zooms in the monitor screen of the second region R2 according to the detected pinch amount. Furthermore, the app execution unit 108a sets the zoom magnification matching the focal length of the scale positioned at the index ID1 by rotation of the magnification setting ring CB.

Note that the seamless zoom UI described so far is a UI corresponding to the M1 part described with reference to FIGS. 6 and 7, the M5 part described with reference to FIGS. 10 and 11, and the like. Furthermore, the “telephoto optical zoom UI” can be defined for the seamless zoom UI. The telephoto optical zoom UI is a UI corresponding to the third magnification setting button TB illustrated in FIGS. 6, 8, and 12 to 15, the section OZS illustrated in FIGS. 14 and 15, and the like.

### 3 PROCESSING PROCEDURE

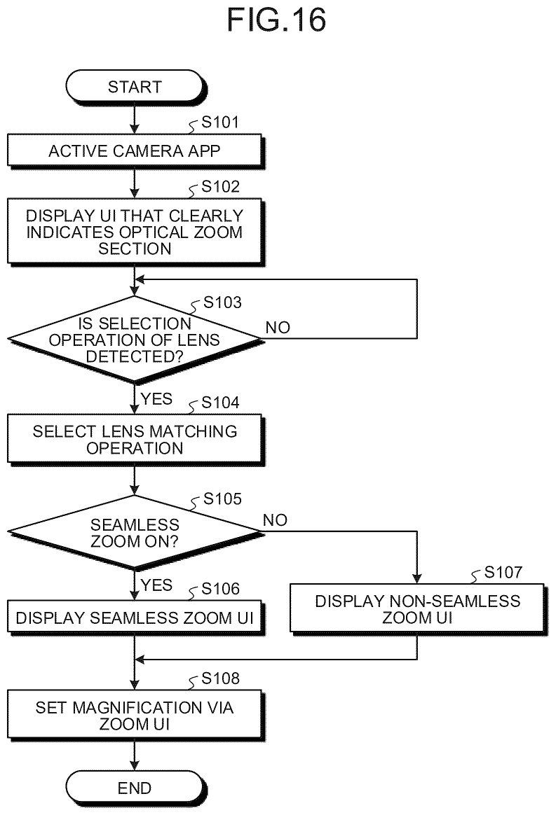

Next, a processing procedure executed by the smartphone 10 according to the embodiment of the present disclosure will be described with reference to FIG. 16. FIG. 16 is a flowchart illustrating the processing procedure executed by the smartphone 10. Note that, in a case of a combination of the type and the photographing mode of the camera app that displays the seamless zoom UI at all times, steps S105 and S107 are omitted.

As illustrated in FIG. 16, the smartphone 10 first activates the camera app (Step S101). Furthermore, the smartphone 10 displays as the UI related to the zoom function the UI that clearly indicates the optical zoom section (85 mm to 125 mm) for the zoom lens in the case where the plurality of camera lenses 17 of the different focal lengths including the zoom lens are provided (Step S102).

Furthermore, the smartphone 10 determines whether or not a selection operation of the camera lens 17 has been detected (Step S103). When the selection operation of the camera lens 17 is not detected (Step S103, No), Step S103 is repeated.

When detecting the selection operation of the camera lens 17 (Step S103, Yes), the smartphone 10 selects the camera lens 17 matching the operation (Step S104).

Furthermore, the smartphone 10 determines whether the on/off settings of the seamless zoom UI are on (Step S105). Here, in a case where the settings are on (Step S105, Yes), the smartphone 10 displays the seamless zoom UI (Step S106).

On the other hand, in a case where the settings are off (Step S105, No), the smartphone 10 displays a non-seamless zoom UI that is a UI related to the zoom function other than the seamless zoom UI (Step S107).

Furthermore, the smartphone 10 sets the magnification via the zoom UI that is a UI related to the displayed zoom function (Step S108), and finishes the processing.

### 4. MODIFICATION

Meanwhile, the above-described embodiment of the present disclosure can include several modifications.

Although the above described embodiment of the present disclosure has described the example where the smartphone 10 includes the camera 101, and the camera app is a photographing app that uses this camera 101, the smartphone 10 and the camera 101 may be separate bodies.

That is, in such a case, a camera that is an external apparatus separate from the smartphone 10 includes a plurality of camera lenses of different focal lengths including an optical zoom lens. Furthermore, the smartphone 10 functions as an information processing apparatus, that is, a so-called remote controller that remotely controls the camera via the camera app by wired communication or wireless communication via the communication unit 104.

Furthermore, although the embodiment of the present disclosure has described the example where the camera 101 is an example of an optical system device, and the camera app is an operation app for this optical system device, the optical system device is not limited to the camera 101. For example, the optical system device may be a telescope or the like.

That is, in such a case, the telescope includes the plurality of lenses of the different focal lengths including the zoom lens, and the operation app of this telescope displays the UI that clearly indicates the optical zoom section of the zoom lens for the zoom function of the lens of the telescope. Furthermore, the app displays the seamless zoom UI that continuously indicates the range from the minimum magnification to the maximum magnification that can be set to all of the plurality of lenses.

Furthermore, it is possible to manually perform all or part of processing described as the processing that is automatically performed among each processing described in the above-described embodiment of the present disclosure, or automatically perform by a known method all or part of processing described as the processing that is manually performed. Furthermore, the processing procedures, the specific names, and the information including the various items of data and the parameters illustrated in the above description and drawings can be arbitrarily changed unless otherwise designated. For example, the various pieces of information illustrated in each drawing are not limited to the illustrated information.

Furthermore, each component of each illustrated device is functionally conceptual, and does not necessarily need to be physically configured as illustrated. That is, the specific modes of distribution and integration of each device are not limited to the illustrated modes, and all or part of the components can be functionally or physically distributed/integrated and configured in an arbitrary unit according to various loads, usage conditions, and the like.

Furthermore, the above-described embodiment of the present disclosure can be combined as appropriate within a range without making processing contents contradict each other. Furthermore, the order of each step illustrated in the sequence diagram or the flowchart of the present embodiment can be changed as appropriate.

### 5. HARDWARE CONFIGURATION

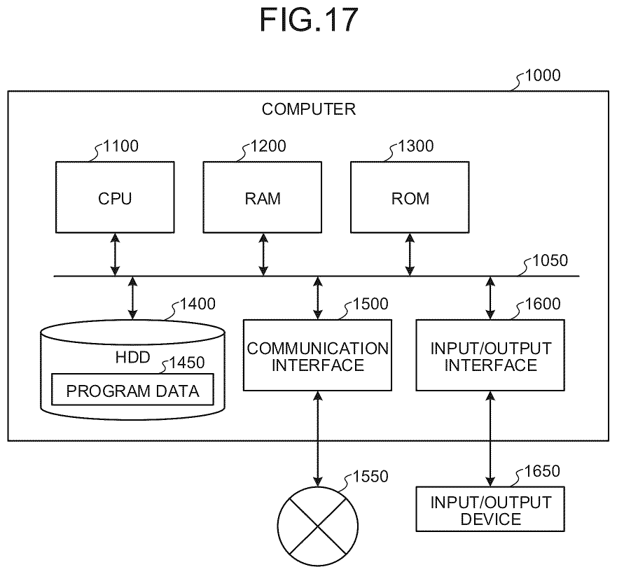

The smartphone 10 according to the above-described embodiment of the present disclosure is implemented as, for example, a computer 1000 employing a configuration as illustrated in FIG. 17. FIG. 17 is a hardware configuration diagram illustrating an example of the computer 1000 that implements the functions of the smartphone 10. The computer 1000 includes a CPU 1100, a RAM 1200, a ROM 1300, a Hard Disk Drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 expands in the RAM 1200 a program stored in the ROM 1300 or the HDD 1400, and executes processing corresponding to various programs.

The ROM 1300 stores a boot program such as a Basic Input Output System (BIOS) executed by the CPU 1100 when the computer 1000 is activated, a program that depends on hardware of the computer 1000, and the like.

The HDD 1400 is a computer-readable recording medium that non-transiently records a program executed by the CPU 1100, data used by this program, and the like. More specifically, the HDD 1400 is a recording medium that records a program according to the present disclosure that is an example of program data 1450.

The communication interface 1500 is an interface for the computer 1000 to connect to an external network 1550 (e.g., the Internet). For example, the CPU 1100 receives data from another equipment, and transmits data generated by the CPU 1100 to the another equipment via the communication interface 1500.

The input/output interface 1600 is an interface for connecting an input/output device 1650 and the computer 1000. For example, the CPU 1100 accepts data from an input device such as a keyboard and a mouse via the input/output interface 1600. Furthermore, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The media are, for example, optical recording media such as a Digital Versatile Disc (DVD) and a Phase change rewritable Disk (PD), magneto-optical recording media such as a Magneto-Optical disk (MO), tape media, magnetic recording media, semiconductor memories, or the like.

In a case where, for example, the computer 1000 functions as the smartphone 10 according to the embodiment, the CPU 1100 of the computer 1000 implements the functions of the control unit 108 and the like by executing the program loaded on the RAM 1200. Furthermore, the HDD 1400 stores the program according to the present disclosure and data in the storage unit 107. Note that, although the CPU 1100 reads the program data 1450 from the HDD 1400 to execute, these programs may be acquired from another apparatus via the external network 1550 in another example.

### 6. CONCLUSION

As described above, according to the embodiment of the present disclosure, the smartphone 10 (corresponding to an example of the “information processing apparatus”) includes the app execution unit 108a that is provided to be able to execute the camera app (corresponding to the example of the “operation app”) of the camera 101 (corresponding to the example of the “optical system device”) including the plurality of camera lenses 17 (corresponding to the example of the “lenses”) of the different focal lengths including the zoom lens, and the display control unit 108b that causes the display unit 106 to display the first user interface that clearly indicates the optical zoom section of the zoom lens for the zoom function of the camera lens 17 included in the camera app. Consequently, it is possible to further improve convenience at the time of use of the camera app.

Although the embodiment of the present disclosure has been described above, the technical scope of the present disclosure is not limited to the above-described embodiment as is, and various modifications can be made without departing from the gist of the present disclosure. Furthermore, components according to different embodiments and modifications may be appropriately combined.

Furthermore, the effects according to each embodiment described in the description are merely examples and are not limited thereto, and other effects may be provided.

Note that the technique according to the present disclosure can also employ the following configurations.

(1)

An information processing apparatus comprising:
an app execution unit that can execute an operation app of an optical system device including a plurality of lenses of different focal lengths including a zoom lens; and
a display control unit that causes a display unit to display a first user interface that clearly indicates a section of optical zoom of the zoom lens for a zoom function of the lens included in the operation app.
   (2)

The information processing apparatus according to (1), wherein
the display control unit
displays a second user interface that continuously indicates a range from a minimum magnification to a maximum magnification that can be set to all of a plurality of the lenses.
   (3)

The information processing apparatus according to (2), wherein
the display control unit
displays the second user interface that continuously indicates the range including a range of digital zoom.
   (4)

The information processing apparatus according to (3), wherein
the display control unit
displays the first user interface that is an oval button indicating a section of a value matching a variable focal length of the zoom lens.
   (5)

The information processing apparatus according to (3) or (4), wherein
the display control unit
displays the first user interface that is an operation component on which scales that indicate focal lengths matching magnifications of the optical zoom and the digital zoom are indicated is indicated on an outer circumference of an arc shape, and that is rotatably provided around a center of the arc, and
on the operation component,
the section of the optical zoom is clearly indicated separately from a section of the digital zoom.
   (6)

The information processing apparatus according to any one of (1) to (5), further comprising
the optical system device.
   (7)

The information processing apparatus according to any one of (1) to (6), wherein
the optical system device is an external apparatus, and remotely controls the optical system device by communication via the operation app.
   (8)

The information processing apparatus according to any one of (1) to (7), wherein
the optical system device is a camera.
   (9)

An information processing method comprising:
executing an operation app of an optical system device including a plurality of lenses of different focal lengths including a zoom lens; and
causing a display unit to display a user interface that clearly indicates a section of optical zoom of the zoom lens for a zoom function of the lens included in the operation app.
   (10)

A program causing a computer to execute:
executing an operation app of an optical system device including a plurality of lenses of different focal lengths including a zoom lens; and
causing a display unit to display a user interface that clearly indicates a section of optical zoom of the zoom lens for a zoom function of the lens included in the operation app.

### REFERENCE SIGNS LIST

10 SMARTPHONE
17 CAMERA LENS
17-T THIRD LENS
17-U FIRST LENS
17-W SECOND LENS
101 CAMERA
102 FOCAL LENGTH VARYING MECHANISM
103 INERTIAL SENSOR UNIT
104 COMMUNICATION UNIT
105 OPERATION UNIT
106 DISPLAY UNIT
107 STORAGE UNIT
107a APP INFORMATION
108 CONTROL UNIT
108a APP EXECUTION UNIT
108b DISPLAY CONTROL UNIT
108c COMMUNICATION CONTROL UNIT
CB MAGNIFICATION SETTING RING
ID1 INDEX
LS LENS SELECTION SCREEN
OZS SECTION
R1 FIRST REGION
R2 SECOND REGION
R3 THIRD REGION
SL SLIDER
TB THIRD MAGNIFICATION SETTING BUTTON
TS TOUCH SCREEN
UB FIRST MAGNIFICATION SETTING BUTTON
WB SECOND MAGNIFICATION SETTING BUTTON

1. An information processing apparatus comprising:
an app execution unit that can execute an operation app of an optical system device including a plurality of lenses of different focal lengths including a zoom lens; and
a display control unit that causes a display unit to display a first user interface that clearly indicates a section of optical zoom of the zoom lens for a zoom function of the lens included in the operation app.

2. The information processing apparatus according to claim 1, wherein
the display control unit
displays a second user interface that continuously indicates a range from a minimum magnification to a maximum magnification that can be set to all of a plurality of the lenses.

3. The information processing apparatus according to claim 2, wherein
the display control unit
displays the second user interface that continuously indicates the range including a range of digital zoom.

4. The information processing apparatus according to claim 1, wherein
the display control unit
displays the first user interface that is an oval button indicating a section of a value matching a variable focal length of the zoom lens.

5. The information processing apparatus according to claim 3, wherein
the display control unit
displays the first user interface that is an operation component on which scales that indicate focal lengths matching magnifications of the optical zoom and the digital zoom are indicated is indicated on an outer circumference of an arc shape, and that is rotatably provided around a center of the arc, and
on the operation component,
the section of the optical zoom is clearly indicated separately from a section of the digital zoom.

6. The information processing apparatus according to claim 1, further comprising
the optical system device.

7. The information processing apparatus according to claim 1, wherein
the optical system device is an external apparatus, and remotely controls the optical system device by communication via the operation app.

8. The information processing apparatus according to claim 1, wherein
the optical system device is a camera.

9. An information processing method comprising:
executing an operation app of an optical system device including a plurality of lenses of different focal lengths including a zoom lens; and
causing a display unit to display a user interface that clearly indicates a section of optical zoom of the zoom lens for a zoom function of the lens included in the operation app.

10. A program causing a computer to execute:
executing an operation app of an optical system device including a plurality of lenses of different focal lengths including a zoom lens; and
causing a display unit to display a user interface that clearly indicates a section of optical zoom of the zoom lens for a zoom function of the lens included in the operation app.
